(19) United States
(12) Patent Application Publication
(10) Pub. No.: US 2005/0281221 A1
(43) Pub. Date: Dec. 22, 2005

(54) System and method for allocating an adaptive modulation and coding subchannel in an orthogonal frequency division multiple access communication system with multiple antennas

(75) Inventors: Won-Il Roh, Yongin-si (KR); Jae-Ho Jeon, Seongnam-si (KR); Seung-Joo Maeng, Seongnam-si (KR); Ji-Ho Jang, Seoul (KR); Jeong-Tae Oh, Yongin-si (KR); Kyun-Byoung Ko, Goyang-si (KR); Pan-Yuh Joo, Yongin-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/156,786

(22) Filed: Jun. 20, 2005

(30) Foreign Application Priority Data
Jun. 19, 2004 (KR) 2004/45892

(51) Int. Cl. H04Q 7/00

(52) U.S. Cl. 370/328

(57) ABSTRACT

A system and method for allocating an adaptive modulation and coding (AMC) subchannel in a communication system for transmitting and receiving data through at least one antenna. A receiver examines at least one channel received from a transmitter, selects antenna transmission mode based on the examined at least one channel, selects an optimum frequency band based on the selected mode, and sends feedback information including selection information to the transmitter. The transmitter receives the feedback information from the receiver and allocates a frequency band to the receiver according to the received feedback information.

### PRIORITY

This application claims priority under 35 U.S.C. § 119 to an application entitled “System and Method for Allocating an Adaptive Modulation and Coding Subchannel in an Orthogonal Frequency Division Multiple Access Communication System with Multiple Antennas” filed in the Korean Intellectual Property Office on Jun. 19, 2004 and assigned Serial No. 2004-45892, the contents of which are incorporated herein by reference.

### BACKGROUND OF THE INVENTION

1. Field of the Invention

The present invention generally relates to an orthogonal frequency division multiple access (OFDMA) communication system, and more particularly to a system and method for allocating an adaptive modulation and coding (AMC) subchannel in an OFDMA communication system for transmitting and receiving data through at least one antenna.

2. Description of the Related Art

A large amount of research is currently being conducted on 4^{th} generation (4G) communication systems, which will be the next generation communication systems, for providing users with various services based on high speed and high quality of service (QoS). The next generation high-speed communication systems must be capable of processing and transmitting various information such as video, radio data, etc., in addition to a voice service. More specifically, research is currently being conducted on an orthogonal frequency division multiple access (OFDMA) communication system for transmitting high-speed data through a wired/wireless channel among the 4G communication systems.

When a data transmission error occurs due to, for example, multipath interference, shadowing, radio wave attenuation, time-variant noise, interference and fading, etc., in a wireless channel environment of the 4G communication system different from a wired channel environment, information may be lost. To reduce information loss, various error control techniques are used according to channel characteristics. For example, to overcome unstable communication due to the fading effect, a diversity scheme is used.

The diversity scheme is divided into time, frequency, and antenna diversity schemes. The antenna diversity scheme serving as a space diversity scheme uses multiple antennas. Accordingly, the antenna diversity scheme is divided into a single-input multiple-output (SIMO) scheme, a multiple-input single-output (MISO) scheme, and a multiple-input multiple-output (MIMO) scheme. The SIMO or MISO scheme uses multiple receive or transmit antennas. The MIMO scheme uses multiple receive antennas and multiple transmit antennas.

More specifically, when the OFDMA communication system uses the MISO or MIMO scheme, it can obtain a high transmission gain from the transmit antenna diversity or spatial multiplexing diversity. In the transmit antenna diversity scheme or the spatial multiplexing diversity scheme, the transmission gain differs according to channel state or according to open or closed loop structure for transmitting weight values of multiple transmit antennas when a base station (BS) sends signals through the transmit antennas. This MIMO or MISO technology can be applied for a downlink or uplink of the OFDMA communication system.

An adaptive modulation and coding (AMC) scheme allocates an optimum frequency band to a specific terminal in real time using variation characteristics of a frequency band and transmits data at an optimum transmission rate according to channel state of the allocated band. The AMC scheme is applied to an Institute of Electrical and Electronics Engineers (IEEE) 802.16d communication system for providing a wireless broadband Internet service.

More specifically, because the IEEE 802.16d communication system uses a wide data transmission bandwidth, it can transmit a larger amount of data in a short time than other wireless communication systems for the existing voice service. In the IEEE 802.16d communication system, multiple users share a common channel and thus the channel can be efficiently used. That is, all users connected to a BS share a common channel and the BS assigns an interval in which each user uses the channel for each downlink or uplink frame in the IEEE 802.16d communication system. Accordingly, the BS must notify the users of downlink and uplink connection information for every frame such that the users can share the common channel.

A MAP message including the downlink and uplink connection information is included in a head part of each frame, and is sent to all the users.

A subscriber station (SS) sends downlink channel reception state information to the BS through a specific uplink channel, such that the BS can effectively perform downlink transmission. The uplink channel used to transmit the downlink channel reception state information is used for a channel quality indicator (CQI). The CQI is applied for many communication systems including the IEEE 802.16d communication system.

However, because an AMC subchannel allocation method of the BS with at least one antenna is different from that of the BS with a single antenna, an AMC band selection method and an antenna transmission mode selection method must be defined.

It is inefficient for the AMC band selection method applied to the existing single-input single-output (SISO) system to be applied to the MISO or MIMO antenna system.

Further, when the SS selects an AMC band and antenna transmission mode, for example, MISO or MIMO mode, selection criteria are required.

### SUMMARY OF THE INVENTION

It is, therefore, an aspect of the present invention to provide a system and method for allocating an adaptive modulation and coding (AMC) subchannel to each subscriber station (SS) through downlink or uplink channel estimation in an antenna system having at least one antenna.

It is another aspect of the present invention to provide a system and method for selecting antenna transmission mode in which an AMC band can be applied for an antenna system having at least one antenna.

The above and other aspects of the present invention can be achieved by a method for allocating a frequency band to a receiver in a communication system including a transmitter for transmitting data through at least one antenna and receivers for receiving data through at least one antenna. The method comprises the steps of examining at least one channel received by the receiver from the transmitter; selecting antenna transmission mode based on the examined at least one channel; selecting an optimum frequency band based on the selected mode; sending feedback information comprising the selection information to the transmitter; receiving the feedback information; and allocating a frequency band from the transmitter to the receiver according to the received feedback information.

Additionally, the present invention provides a system for allocating a frequency band in a communication system. The system comprises a receiver for examining at least one received channel, selecting antenna transmission mode based on the examined at least one channel, selecting an optimum frequency band based on the selected mode, and sending feedback information including the selection information; and a transmitter for receiving the feedback information from the receiver and allocating a frequency band to the receiver according to the received feedback information.

### BRIEF DESCRIPTION OF THE DRAWINGS

The above and other aspects and advantages of the present invention will be more clearly understood from the following detailed description taken in conjunction with the accompanying drawings, in which:

FIG. 1 illustrates a system of the multiple-input single-output (MISO) mode in accordance with an embodiment of the present invention;

FIG. 2 is a graph illustrating an operation of a MISO mode system in accordance with an embodiment of the present invention;

FIG. 3 illustrates a system of the multiple-input multiple-output (MIMO) mode in accordance with an embodiment of the present invention;

FIG. 4 is a graph illustrating an operation of a MIMO mode system in accordance with an embodiment of the present invention;

FIG. 5 illustrates feedback information in accordance with an embodiment of the present invention;

FIG. 6 illustrates allocation information for AMC subchannels in accordance with an embodiment of the present invention;

FIG. 7 illustrates a macro diversity system in accordance with an embodiment of the present invention; and

FIG. 8 is a graph illustrating an operation of a macro diversity system in accordance with an embodiment of the present invention.

### DETAILED DESCRIPTION OF THE PREFERRED EMBODIMENTS

Preferred embodiments of the present invention will now be described in detail herein below with reference to the accompanying drawings. In the drawings, the same or similar elements are denoted by the same reference numerals even though they are depicted in different drawings. In the following description, detailed descriptions of functions and configurations incorporated herein that are well known to those skilled in the art are omitted for clarity and conciseness.

The present invention proposes technology for allocating an adaptive modulation and coding (AMC) subchannel to each receiver through downlink or uplink channel estimation in a communication system for transmitting and receiving data through at least one antenna. In the communication system, a receiver examines a channel of data received through an antenna, and selects antenna transmission mode according to a result of the examination. Thereafter, the receiver selects an optimum AMC band, i.e., a frequency band, in the selected antenna transmission mode, and sends, to a transmitter, feedback information including an index of the selected antenna transmission mode and an index of the selected AMC band.

According to the feedback information from the receiver, the transmitter allocates a frequency band, i.e., an AMC subchannel, to the receiver and sends data to the receiver using the allocated AMC subchannel.

In accordance with an embodiment of the present invention, a subscriber station (SS) selects an antenna transmission mode, selects an optimum AMC band in the selected antenna transmission mode, and sends feedback information including a selected antenna index and a selected AMC band index to a base station (BS). The BS allocates an AMC subchannel to the SS, such that data can be transmitted.

For convenience of explanation, it is assumed that the transmitter is a BS and the receiver is an SS in accordance with an embodiment of the present invention. However, this embodiment is for the purpose of description and should not be regarded as limiting the present invention.

In the following description of the present invention, the receiver, i.e., the SS, selects an AMC band and antenna transmission mode. Alternatively, the transmitter, i.e., the BS, may select the AMC band and the antenna transmission mode. More specifically, the present invention is applied to downlink data transmission between the transmitter and the receiver. However, the present invention can be applied to uplink data transmission.

Parameters used in the description of the present invention are defined as follows.

M: Number of transmit antennas at a BS.

N: Number of receive antennas at an SS.

P: Number of SSs connected to one BS.

K: Number of AMC bands into which the entire frequency band is divided.

H: Channel matrix with dimensions of N×M in a multiple-input multiple-output (MIMO) system. The singular value decomposition (SVD) of H consists of three matrices (U,Σ,V), where U and V are the left and right eigenvector matrices, respectively, and Σ is a diagonal matrix of the singular values of H. The SVD of H can be written as H=UΣV*, where V* denotes the transpose conjugate of V.

hₙₘ^{p}(k): Channel between the m-th transmit antenna and the n-th receive antenna in the k-th frequency of the downlink for the p-th SS at a specific time. When hₙₘ^{p}(k) is combined with the antenna space and is expressed in a two-dimensional matrix form, H^{p}(k) is computed. The matrix dimension is (Rows, Columns)=(Number of receive antennas N, Number of transmit antennas M). H^{p}(k) is the channel matrix for a specific frequency. This channel matrix varies in real time when the SS is on the move.

gₙₘ^{p}(k): Signal to noise ratio (SNR) indicating a state of each channel hₙₘ^{p}(k). gₙₘ^{p}(k) is defined as shown in Equation (1).
gₙₘ(k)=|hₙₘ(k)|² (1)

That is, gₙₘ^{p}(k) denotes an SNR of a channel between the m-th transmit antenna and the n-th receive antenna in the k-th frequency of the downlink for the p-th SS at a specific time. For example, gₙₘ^{p}(k) denotes the SNR of the channel between the n-th receive antenna of the SS and the m-th transmit antenna of the BS in the k-th frequency when the BS sends data through the m-th transmit antenna.

Adjacent frequency subcarriers have almost the same gₙₘ^{p}(k) value. In an AMC method, modulation and coding optimized by the gₙₘ^{p}(k) value are applied to a corresponding AMC band.

A. AMC Band Selection Process

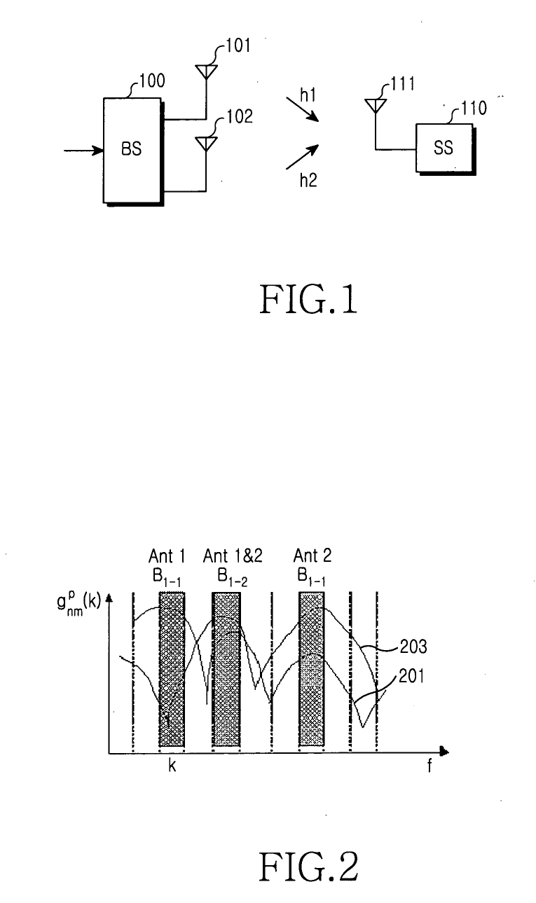

The AMC band selection process of the SS in accordance with an embodiment of the present invention will now be described herein below with reference to FIGS. 1 to 4.

The AMC band selection process is performed after an antenna transmission mode selection process. For a better understanding of the present invention, the AMC band selection process for when the antenna transmission mode is multiple-input single-output (MISO) or MIMO mode will be described.

I. AMC Band Selection of SS in Antenna System Based on MISO Mode

FIG. 1 illustrates an antenna system in the MISO mode. Referring to FIG. 1, a BS 100 with two antennas 101 and 102 transmits downlink data to an SS 110 with a single antenna 111. The BS 100 encodes data using space-time processing (STP) technology and transmits the encoded data through the two antennas 101 and 102. The BS 100 transmits the data using an adaptive antenna scheme. When the data is transmitted using the adaptive antenna scheme, two channels h1 and h2 are transmission paths for transmitting the data to the SS 110 through the two antennas 101 and 102. These two channels h1 and h2 with small correlation have different frequency selectivities in a band for orthogonal frequency division multiple access (OFDMA).

The two channels h1 and h2 having the different frequency selectivities as described in relation to FIG. 1 are illustrated in FIG. 2. In FIG. 2, the x-axis represents frequency (f), and the y-axis represents power of the channels h1 and h2 transmitted from the BS 100 to the p-th SS 110 in the k-th frequency. A power value is expressed by gₙₘ^{p}(k). For convenience of explanation, the antenna 101 of the two antennas of the BS 100 as illustrated in FIG. 1 is referred to as the first antenna (Ant 1), and the antenna 102 of the two antennas of the BS 100 as illustrated in FIG. 1 is referred to as the second antenna (Ant 2) in FIG. 2.

In FIG. 2, the first curve 201 denotes a power value g₁₂^{p}(k) of the channel h1 received by the antenna 111 of the SS 110 from the first antenna 101 of the BS 100, and the second curve 203 denotes a power value g₁₂^{p}(k) of the channel h2 received by the antenna 111 of the SS 110 from the second antenna 102 of the BS 100. Channel characteristics of the two channels h1 and h2 have little correlation, and the SS 110 selects an AMC band on the basis of the following two methods in the MISO mode.

Method I-1

According to the first AMC band selection method (Method I-1), the SS 110 selects a band B₁ with the largest value of channel power values of all channels received from the two transmit antennas. The selected band B₁ is defined as shown in Equation (2).

$${B}_{1} = arg {max}_{m , k} {g}_{m} ( k ) \qquad ( 2 )$$

Using Equation (2), the SS 110 selects the band B₁ with the largest power value in the k-th frequency from bands of channels received from m transmit antennas.

Referring to FIG. 2, the SS 110 selects a band B₁₋₁ in which the first curve 201 and the second curve 203 have peaks. In the bands of the channels h1 and h2 received from the first antenna 101 and the second antenna 102, the band B₁₋₁ has the largest power values of g₁₁^{p}(k) and g₁₂^{p}(k) in the k-th frequency.

Upon selecting the band B₁₋₁ using Equation (2), the SS 110 includes, in feedback information, an index of the selected band B₁₋₁, and an antenna index of the BS 100 transmitting a channel with the largest power value in the selected band B₁₋₁, and sends the feedback information to the BS 100.

Method I-2

According to the second AMC band selection method (Method I-2), the SS 110 selects a band B₂ in which a sum of reception power values of at least two received channels is largest. The selected band B₂ is defined as shown in Equation (3).

$${B}_{2} = arg {max}_{k} ( {\sum }_{m} {g}_{m} ( k ) ) \qquad ( 3 )$$

Using Equation (3), the SS 110 computes power sums between m channels in the k-th frequency according to bands of channels received from m transmit antennas, and selects the band B₂ with the largest power sum from the bands.

Referring to FIG. 2, the SS 110 selects a band B₁₋₂ with the largest power sum between g₁₁^{p}(k) and g₁₂^{p}(k) in the first curve 201 and the second curve 203. Upon selecting the band B₁₋₂ using Equation (3), the SS 110 includes, in feedback information, an index of the selected band B₁₋₂, and sends the feedback information to the BS 100.

II. AMC Band Selection of SS in Antenna System Based on MIMO Mode

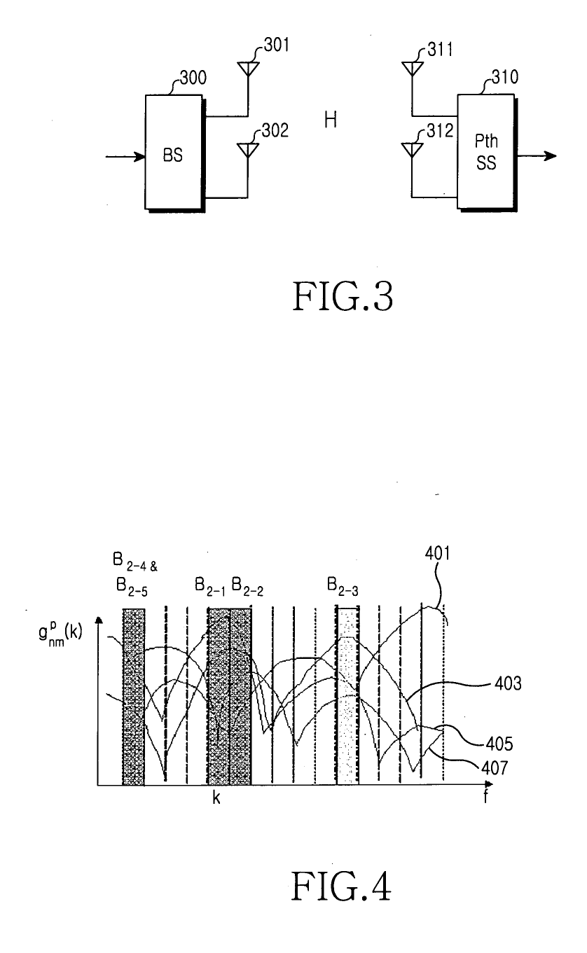

FIG. 3 illustrates an antenna system in the MIMO mode. Referring to FIG. 3, a BS 300 with two antennas 301 and 302 sends downlink data to an SS 310 with two antennas 311 and 312. The BS 300 encodes data using STP technology and transmits the encoded data through the two antennas 301 and 302. The BS 300 transmits data using an adaptive antenna scheme. The SS 310 decodes STP signals received through the two antennas 311 and 312. For convenience of explanation, the antenna 301 of the two antennas of the BS 300 is referred to as the first antenna of the BS 300, the antenna 302 of the two antennas of the BS 300 is referred to as the second antenna of the BS 300, the antenna 311 of the two antennas of the SS 310 is referred to as the first antenna of the SS 310, and the antenna 312 of the two antennas of the SS 310 is referred to as the second antenna of the SS 310.

There are four channels from the two antennas 301 and 302 of the BS 300 to the two antennas 311 and 312 of the SS 310. The channels are expressed by a 2×2 channel matrix H^{p}(k) as shown in Equation (4).

$${H}^{p} ( k ) = [ \begin{matrix}{h}_{11}^{p} ( k ) & {h}_{12}^{p} ( k ) \\ {h}_{21}^{p} ( k ) & {h}_{22}^{p} ( k )\end{matrix} ] \qquad ( 4 )$$

In Equation (4), h₁₁^{p}(k) denotes a channel between the first antenna 301 of the BS 300 and the first antenna 311 of the SS 310, h₂₁^{p}(k) denotes a channel between the first antenna 301 of the BS 300 and the second antenna 312 of the SS 310, h₁₂^{p}(k) denotes a channel between the second antenna 302 of the BS 300 and the first antenna 311 of the SS 310, and h₂₂^{p}(k) denotes a channel between the second antenna 302 of the BS 300 and the second antenna 312 of the SS 310.

When the BS 300 transmits data using an adaptive antenna scheme, the channels h₁₁^{p}(k), h₁₂^{p}(k), h₂₁^{p}(k), and h₂₂^{p}(k) with little correlation have different frequency selectivities in the entire band for OFDMA.

The four channels with the different frequency selectivities as described in relation to FIG. 3 are illustrated in FIG. 4. In FIG. 4, the x-axis represents frequency (f), and the y-axis represents power of the channels from the BS 300 to the p-th SS 310 in the k-th frequency. A power value is expressed by gₙₘ^{p}(k).

In FIG. 4, the first curve 401 denotes a power value g₁₁^{p}(k) of the channel h₁₁^{p}(k) received by the first antenna 311 of the SS 310 from the first antenna 301 of the BS 300. The second curve 403 denotes a power value g₂₁^{p}(k) of the channel h₂₁^{p}(k) received by the second antenna 312 of the SS 310 from the first antenna 301 of the BS 300. The third curve 405 denotes a power value g₁₂^{p}(k) of the channel h₁₂^{p}(k) received by the first antenna 311 of the SS 310 from the second antenna 302 of the BS 300. The fourth curve 407 denotes a power value g₂₂^{p}(k) of the channel h₂₂^{p}(k) received by the second antenna 312 of the SS 310 from the second antenna 302 of the BS 300.

As illustrated in FIG. 4, the channel characteristics of the four channels have little correlation. The SS 310 selects an AMC band through the following four methods in the MIMO mode. Of course, the present invention can be applied regardless of correlation between the channels.

Method II-1

According to the first AMC band selection method (Method II-1), the SS 310 compares power sums between channels received by the multiple receive antennas from the multiple transmit antennas, and selects a band B₁ The selected band B₁ is defined as shown in Equation (5).

$${B}_{1} = arg {max}_{m , k} ( {\sum }_{n} {g}_{n m} ( k ) ) \qquad ( 5 )$$

Using Equation (5), the SS 310 computes power sums between channels transmitted from each transmit antenna of the BS 300 to the receive antennas of the SS 310 in the k-th frequency, and then selects the band B₁ with the largest power sum.

Referring to FIG. 4, the SS 310 computes a power sum between g₁₁^{p}(k) and g₂₁^{p}(k) of the channels h₁₁^{p}(k) and h₂₁^{p}(k) received by the first antenna 311 and the second antenna 312 of the SS 310 from the first antenna 301 of the BS 300 in the k-th frequency. The SS 310 computes a power sum between g₁₂^{p}(k) and g₂₂^{p}(k) of the channels h₁₂^{p}(k) and h₂₂^{p}(k) received by the first antenna 311 and the second antenna 312 of the SS 310 from the second antenna 302 of the BS 300 in the k-th frequency. Thereafter, the SS 310 selects a band B₂₋₁ with the largest power sum.

Upon selecting the band B₂₋₁, using Equation (5), the SS 310 includes, in feedback information, an index of the selected band B₂₋₁ and an antenna index of the BS 300 transmitting a channel with the largest power sum in the selected band B₂₋₁, and sends the feedback information to the BS 300.

Method II-2

According to the second AMC band selection method (Method II-2) similar to Method I-2 as described above, the SS 310 selects a band B₂. The selected band B₂ is defined as shown in Equation (6).

$${B}_{2} = arg {max}_{m , k} ( {\sum }_{n , m} {g}_{ m} ( k ) ) \qquad ( 6 )$$

Using Equation (6), the SS 310 computes power sums between m×n channels in the k-the frequency of each band, and selects the band B₂ with the largest power sum.

In FIG. 4, the SS 310 selects a band B₂₋₂ in which a power sum of the first curve 401, the second curve 403, the third curve 405, and the fourth curve 407 is largest. Upon selecting the band B₂₋₂ using Equation (6), the SS 310 includes an index of the selected band B₂₋₂ in feedback information and sends the feedback information to the BS 300.

Method II-3

According to the third AMC band selection method (Method II-3) that is not present in the antenna system in the MISO mode, the SS 310 selects a band B₃ with the largest value of singular values computed from the SVD of the channel matrix H^{p}(k) of the given dimensions of N×M. The selected band B₃ is defined as shown in Equation (7).

$${B}_{3} = arg {max}_{k} {σ}_{1} ( H ( k ) ) \qquad ( 7 )$$

Upon selecting the band B₃ using Equation (7), the SS 310 includes an index of the selected band B₃ in feedback information and then sends the feedback information to the BS 300.

Method II-4

According to the fourth AMC band selection method (Method II-4) that is not present in the antenna system in the MISO mode, the SS 310 selects a band B₄ with the largest capacity value in channels based on a theoretical closed loop structure capable of performing transmission according to a channel matrix H^{p}(k) of the given dimensions of N×M. The selected band B₄ is defined as shown in Equation (8).

$${B}_{4} = arg {max}_{k} {C}^{p} ( H ( k ) ) \qquad ( 8 )$$

In Equation (8), C^{p}(H(k)) denotes the theoretical channel capacity value of the channel matrix H^{p}(k) for the p-th SS 310 in the k-th frequency. The unit used for the channel capacity value is bits/s/Hz. The channel capacity value C^{p}(H(k)) of the channel matrix H^{p}(k) is defined as shown in Equation (9).

$${C}^{p} ( H ( k ) ) = {max}_{Tr ( {R}_{xx} ) = P} {log}_{2} det ( {I}_{N} + {H}^{p} ( k ) {R}_{xx} {{H}^{p} ( k )}^{*} ) \qquad ( 9 )$$

The channel capacity value defined by Equation (9) indicates the theoretical maximum spectral efficiency or data transmission rate when a signal transmitted in antenna transmission mode after the ideal encoding process in a corresponding frequency can be decoded without an error in a receiving stage.

Method II-5

According to the fifth AMC band selection method (Method II-5) that is not present in the antenna system in the MISO mode, the SS 310 selects a band B₅ with the largest capacity value in channels based on a theoretical open loop structure capable of performing transmission according to a channel matrix H^{p}(k) of the given dimensions of N×M. The selected band B₅ is defined as shown in Equation (10).

$${B}_{5} = arg {max}_{k} {C}_{open} ( H ( k ) ) \qquad ( 10 )$$

In Equation (10), Cₒₚₑₙ(H(k)) denotes the theoretical open loop based channel capacity value of the channel matrix H^{p}(k) for the p-th SS 310 in the k-th frequency. The unit used for the channel capacity value is bits/s/Hz. The channel capacity value Cₒₚₑₙ(H(k)) for the channel matrix H^{p}(k) is defined as shown in Equation (11).
Cₒₚₑₙ(H(k))=log₂det(I_{N}+P/MH^{p}(k)H^{p}(k)^{•}) (11)

The channel capacity value defined by Equation (11) indicates the theoretical maximum spectral efficiency or data transmission rate where a signal transmitted in antenna transmission mode after the ideal encoding process in a corresponding frequency can be decoded without an error in a receiving stage.

B. Antenna Transmission Mode Selection Process

A process for selecting antenna transmission mode in which the selected AMC band can be applied in accordance with the present invention will now be described herein below. In an OFDMA communication system, the antenna transmission mode selection process of a receiver, i.e., an SS, is determined using the following parameters.
Parameter 1: Given channel matrix H^{p}(k)
Parameter 2: Subscriber basic capability (SBC) of the SS capable of supporting the channel matrix H^{p}(k)
Parameter 3: Feedback channel capacity
Parameter 4: Reliability of traffic requested by the SS

When data is transmitted in the downlink direction, the SS selects the antenna transmission mode for the downlink and sends a request on the basis of the four parameters. A method for selecting the antenna transmission mode using the estimated channel matrix H^{p}(k) in accordance with the present invention will be described.

The SS must be able to support desired mode. In an initial stage in which the SS accesses the network, the handshake is done through a SBC request/response (SBC_REQ/RSP). It is assumed that a feedback channel for supporting specific transmission mode selected by the SS is allocated to the SS. Further, it is assumed that the transmission mode is selected according to characteristics of traffic requested by the SS. For example, it is assumed that transmit antenna diversity mode rather than spatial multiplexing diversity mode is selected as the transmission mode when the SS requests a low transmission rate but receives a signal at a high transmission rate.

Under the assumptions described above, a SIMO, MISO, or MIMO mode is selected as the antenna transmission mode.

Mode 1: SIMO Mode

In the SIMO mode, the BS transmits data through a single antenna and the SS receives data through multiple antennas. When multiple channels can be estimated, a maximal ratio combining (MRC) mode is optimum antenna transmission mode in an interference-free environment. The SS selects an AMC band using Method I-2 described above. Feedback information to be sent from the SS to the BS is a number of the selected band, a channel performance value of the selected band, and an AMC level based on the channel performance value. Required bits for feedback (RBFB) are defined as shown in Equation (12).
ceil(log₂(K))+L (12)

In Equation (12), ceil(log₂(K)) denotes the smallest integer not less than a value of log₂(K), where K is the number of AMC bands, and L denotes the number of bits of one feedback channel for a channel quality indicator (CQI) allocated to the SS on the basis of a single-input single-output (SISO) scheme. In an Institute of Electrical and Electronics Engineers (IEEE) 802.16 communication system, the number of bits L is 4 or 5.

Mode 2: MISO Mode

In the MISO mode, the BS transmits data through multiple antennas, and the SS receives data through a single antenna. In the MISO mode, three space-time modes are possible.

Among the three space-time modes, an antenna selection diversity mode operates such that downlink channels of all bands are estimated and one antenna with the best channel performance among multiple transmit antennas is coupled to the downlink in the best band. In this case, the SS selects an AMC band using Method I-1 as described above. The number of RBFB is defined as shown in Equation (13).
ceil(log₂(K))+L+ceil(log₂(M)) (13)

A transmit antenna diversity mode operates such that space-time coded signals are simultaneously transmitted through two transmit antennas in the same band and the signals are decoded through one receive antenna. In this case, signal power is half less than that of the SISO mode. The coding and decoding process is not directly related to the present invention and therefore its description is omitted here.

When the transmit antenna diversity mode is used, the SS selects an AMC band through Method I-2 as described above. The number of RBFB is defined as shown in Equation (12) as in the SIMO mode.

A transmit antenna array (TxAA) mode is not directly related to the present invention and therefore its description is omitted here. However, when the TxAA mode is used, the SS selects an AMC band through Method I-2 as described above. Theoretically, the TxAA mode is better than transmit diversity mode.

In the TxAA mode, additional feedback information is information about a transmit antenna factor. To add the transmit antenna factor to the feedback information, (M−1)F bits are required, where F denotes the number of bits for indicating one complex antenna factor. If F=L, the number of total RBFB is defined as shown in Equation (14).
ceil(log₂(K))+M·L (14)

Mode 3: MIMO Mode

In the MIMO mode, the BS and the SS each have multiple antennas. In the MIMO mode, four space-time modes are possible.

In an antenna selection diversity mode, i.e., one of the four space-time modes, the SS selects an AMC band using Method II-1. In this case, the number of RBFB is the same as that of the MISO mode. That is, the number of RBFB is defined as shown in Equation (13).

In a transmit antenna diversity mode, the SS selects an AMC band using Method II-2. In this case, the number of RBFB is the same as that of the SIMO mode. That is, the number of RBFB is defined as shown in Equation (12).

In a TxAA mode, an antenna weight vector wr at a receiving stage and an antenna weight vector wt at a transmitting stage are used. In this case, the SS selects an optimum AMC band using Method II-3. In the TxAA mode, all data is transmitted in one band or stream through multiple antennas at the transmitting and receiving stages. That is, spatial multiplexing mode to be described below uses a selected band or stream through the SVD of the channel matrix H^{p}(k), while the TxAA mode transmits data in one stream with the largest singular value.

After the SVD of the channel matrix H^{p}(k), the antenna weight vector wt at the transmitting stage is the first eigenvector of the right eigenvector matrix V, and the antenna weight vector wr at the receiving stage is the first eigenvector of the left eigenvector matrix U. Accordingly, the AMC band selected by the SS is a band with the largest first singular vector among all K bands. In this case, the number of RBFB is expressed by one complex factor. If the number of bits for indicating one complex antenna factor F is equal to L, the number of RBFB is defined as shown in Equation (15).
ceil(log₂(K))+(M+1)·L (15)

In the spatial multiplexing mode, i.e., one of the four space-time modes, AMC band selection of the SS depends upon an open or closed loop structure. When the spatial multiplexing mode uses the closed loop structure, the SS selects an AMC band through Method II-4. When the spatial multiplexing mode uses the open loop structure, the SS selects an AMC band through Method II-5. The closed loop structure can obtain a transmission gain higher than that of the open loop structure, but increases an amount of feedback information required by the BS and the number of computations in the SS.

When the closed loop structure is used, the feedback information required by the BS is the channel matrix H^{p}(k) with the dimensions of N×M. When the number of bits required to express one complex element F is equal to L, the number of RBFB is defined as shown in Equation (16).
ceil(log₂(K))+N·M·L (16)

When the open loop structure is used, the number of RBFB is defined as shown in Equation (12).

All RBFB bits are used when the SS transmits data in one selected AMC band. A description of bits for identifying specific antenna transmission mode is omitted here. For a scheduling gain in the BS, SSs located within the coverage of the BS select multiple antenna transmission modes and multiple AMC bands, and sends selection information to the BS. Selection criteria are based on the parameters described above.

C. BS Scheduling

BS scheduling for implementing the present invention will be described. In accordance with the present invention, the SS selects antenna transmission mode and an AMC band, includes information about the selected antenna transmission mode and the selected AMC band, i.e., an antenna index and an AMC band index, in feedback information, and sends the feedback information to the BS. Upon receiving the information about the selected antenna transmission mode and the selected AMC band from each SS, the BS distributes downlink and uplink resources for subsequent frames.

For the downlink scheduling gain, the SSs send information about multiple antenna transmission modes and AMC bands to the BS through the uplink. This will be described in more detail below with reference to FIG. 5.

FIG. 5 illustrates feedback information in which each SS has included an antenna index and an AMC band index. Each SS sends information about the selected antenna transmission mode and the selected AMC band to the BS. In FIG. 5, the x-axis represents the number of antennas at SS 1, SS 2, and SS 3, and the y-axis represents frequency.

Referring to FIG. 5, each of SS 1, SS 2, and SS 3 have two antennas, and send antenna transmission mode and AMC band information. When the antenna transmission mode is selected, each SS sends selectivity information including the highest selectivity. In FIG. 5, areas 501, 503, and 505 have the highest selectivity for SS 1, SS 2, and SS 3 when the antenna transmission mode is selected.

When transmitting data to multiples SSs, the BS performs a scheduling operation to maximize data transmission efficiency. This BS scheduling is performed such that an estimated sum of transmission rates R^{p}(k) is largest when the k-th frequency is allocated to the p-th SS.

The BS must perform the scheduling operation such that the transmission rate sum is largest, i.e., the spectral efficiency of the entire cell is maximized, when the SSs request frequency resources of different bands. Of course, efficiency in a two-dimensional domain of frequency and time must be maximized using one frame including a plurality of OFDMA symbols.

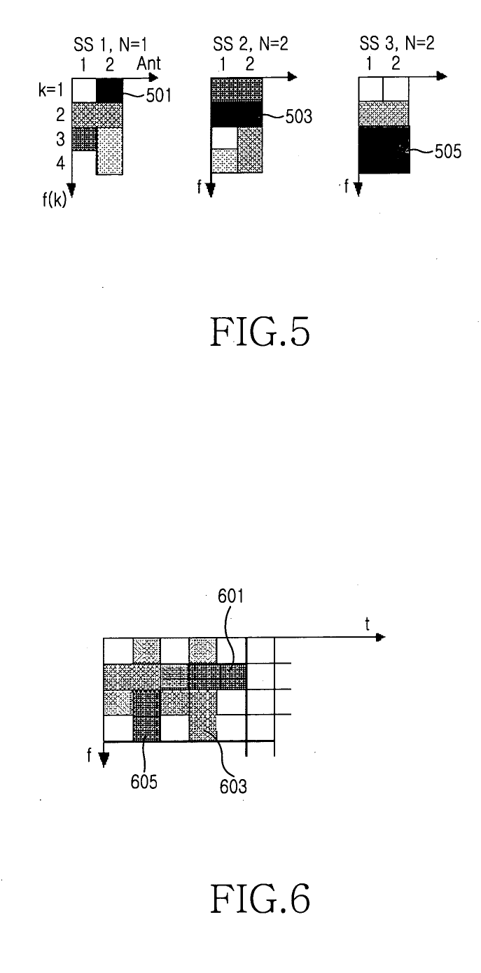

FIG. 6 illustrates allocation information on the frequency and time axes when the BS allocates subchannels. When each SS selects an AMC band and antenna transmission mode, and sends information about the selected AMC band and the selected antenna transmission mode to the BS, the BS allocates an optimum subchannel to each SS. The frequency axis represents an AMC band, and the time axis represents a frame. In FIG. 6, SSs for areas 601 and 603 are different from each other, and antenna transmission modes for areas 605 and 603 are different from each other.

The above-described embodiments of the present invention have been described in relation to specific applications. The present invention can be applied to a macro diversity system in which multiple BSs using at least one antenna support SSs together as well as a micro diversity system in which one BS using multiple antennas supports SSs.

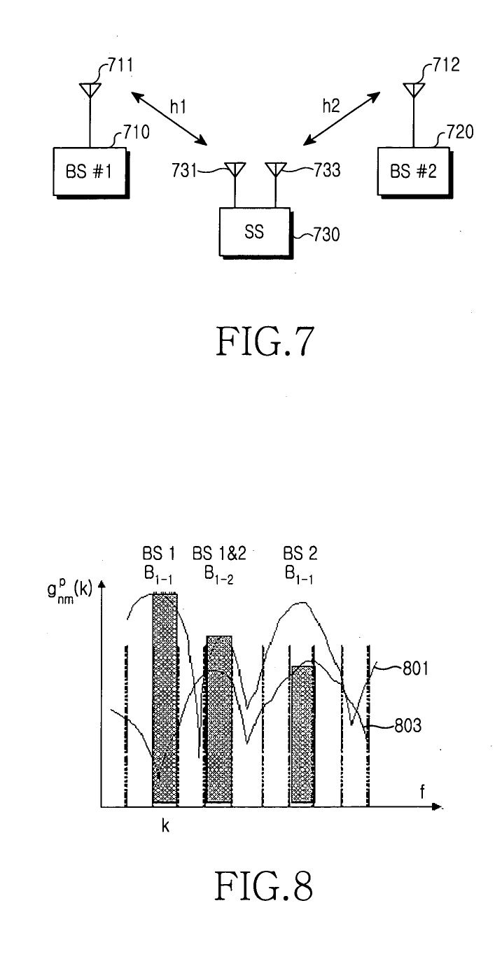

FIG. 7 illustrates a macro diversity system. In FIG. 7, BS #1 710 and BS #2 720 have antennas 711 and 712, respectively. One SS 730 has two antennas 731 and 733. Data is transmitted and received between the SS 730 and the BSs 710 and 720. The BSs 710 and 720 transmit data through an adaptive antenna scheme. For convenience of explanation, the BS 710 is referred to as the first BS and the BS 720 is referred to as the second BS.

When data is transmitted, a channel h1 serves as a transmission path between the antenna 711 of the first BS 710 and the two antennas 731 and 732 of the SS 730, and a channel h2 serves as a transmission path between the antenna 711 of the first BS 710 and the two antennas 731 and 732 of the SS 730. These two channels h1 and h2 with small correlation have different frequency selections in a band for OFDMA. The correlation and frequency selectivity have been described in relation to the systems of FIGS. 1 and 3 and therefore their detailed descriptions are omitted.

The two channels h1 and h2, having the different frequency selectivities, between the SS 730 and the two BSs 710 and 720 in a system structure of FIG. 7 are illustrated in FIG. 8.

In FIG. 8, the x-axis represents frequency (f), and the y-axis represents power of the channels h1 and h2 from the BSs 710 and 720 to the SS 730 in the k-th frequency. A power value is expressed by gₙₘ^{p}(k) as described above. FIG. 8 is similar to FIGS. 2 and 4 and therefore the repeated description is omitted.

In FIG. 8, the first curve 801 denotes a power value of the channel h1 received by the antennas 731 and 733 of the SS 730 from the antenna 711 of the first BS 710, and the second curve 803 denotes a power value of the channel h2 received by the antennas 731 and 733 of the SS 730 from the antenna 712 of the second BS 720. The SS 730 selects an AMC band B₁₋₁ in the k-th frequency through Method I-1, and sends an index of the selected band B₁₋₁ and an antenna index to the BSs 710 and 720. Alternatively, the SS 730 selects an AMC band B₁₋₂ in the k-th frequency through Method I-2, and sends an index of the selected band B₁₋₂ and an antenna index to the BSs 710 and 720.

As is apparent from the above description, the present invention examines a channel, selects antenna transmission mode and an adaptive modulation and coding (AMC) band, and allocates an AMC subchannel in a communication system for transmitting and receiving data using at least one antenna. Therefore, the present invention can improve efficiency of using limited frequency resources in the communication system by combining an optimum AMC band with multiple antennas.

Although preferred embodiments of the present invention have been disclosed for illustrative purposes, those skilled in the art will appreciate that various modifications, additions, and substitutions are possible, without departing from the spirit and scope of the present invention. Therefore, the present invention is not limited to the above-described embodiments, but is defined by the following claims, along with their full scope of equivalents.

1. A method for allocating a frequency band to a receiver in a communication system including a transmitter for transmitting data through at least one antenna and receivers for receiving data through at least one antenna, comprising the steps of:
examining at least one channel received by the receiver from the transmitter;
selecting antenna transmission mode based on the examined at least one channel;
selecting an optimum frequency band based on the selected mode;
sending feedback information comprising the selection information to the transmitter;
receiving the feedback information; and
allocating a frequency band from the transmitter to the receiver according to the received feedback information.

2. The method of claim 1, further comprising the step of:
transmitting data from the transmitter to the receiver using the allocated frequency band.

3. The method of claim 1, wherein the feedback information includes at least one of an index of the antenna transmission mode and an index of the frequency band.

4. The method of claim 3, wherein the index of the frequency band includes at least one of a number of the frequency band, channel performance information in the frequency band, and frequency band level information mapped to the performance information.

5. The method of claim 1, wherein the step of selecting the antenna transmission mode comprises the step of:
selecting a maximal ratio combining (MRC) mode and the optimum frequency band, when the examined at least one channel is associated with a single-input multiple-output (SIMO).

6. The method of claim 5, wherein the step of selecting the frequency band comprises the steps of:
measuring channel power values associated with frequency bands;
computing power sums between the measured channel power values according to the frequency bands; and
selecting a frequency band with a largest power sum.

7. The method of claim 1, wherein the step of selecting the antenna transmission mode comprises the step of:
selecting an antenna selection diversity mode and the optimum frequency band, when the examined at least one channel is associated with a multiple-input single-output (MISO).

8. The method of claim 7, wherein the step of selecting the frequency band comprises the steps of:
measuring channel power values associated with frequency bands; and
selecting a frequency band with a largest power value of the measured channel power values.

9. The method of claim 1, wherein the step of selecting the antenna transmission mode comprises the step of:
selecting a transmit antenna diversity mode and the optimum frequency band, when the examined at least one channel is associated with a multiple-input single-output (MISO).

10. The method of claim 9, wherein the step of selecting the frequency band comprises the steps of:
measuring channel power values associated with frequency bands;
computing power sums between the measured channel power values according to the frequency bands; and
selecting a frequency band with a largest power sum.

11. The method of claim 1, wherein the step of selecting the antenna transmission mode comprises the step of:
selecting a transmit antenna array mode and the optimum frequency band, when the examined at least one channel is associated with a multiple-input single-output (MISO).

12. The method of claim 11, wherein the step of selecting the frequency band comprises the steps of:
measuring channel power values associated with frequency bands;
computing power sums between the measured channel power values according to the frequency bands; and
selecting a frequency band with a largest power sum.

13. The method of claim 11, further comprising the step of:
adding information about a transmit antennas factor to the feedback information from the receiver selecting the transmit antenna array mode.

14. The method of claim 1, wherein the step of selecting the antenna transmission mode comprises the step of:
selecting an antenna selection diversity mode and the optimum frequency band, when the examined at least one channel is associated with a multiple-input multiple-output (MIMO).

15. The method of claim 14, wherein the step of selecting the frequency band comprises the steps of:
measuring channel power values associated with frequency bands;
computing power sums between the measured channel power values according to the input channels; and
selecting a frequency band with a largest power sum.

16. The method of claim 1, wherein the step of selecting the antenna transmission mode comprises the step of:
selecting a transmit antenna diversity mode and the optimum frequency band, when the examined at least one channel is associated with a multiple-input multiple-output (MIMO).

17. The method of claim 16, wherein the step of selecting the frequency band comprises the steps of:
measuring channel power values associated with frequency bands;
summing the channel power values according to input channels;
computing power sums between the summed channel power values according to the frequency bands; and
selecting a frequency band with a largest power sum.

18. The method of claim 1, wherein the step of selecting the antenna transmission mode comprises the step of:
selecting a transmit antenna array mode and the optimum frequency band, when the examined at least one channel is associated with a multiple-input multiple-output (MIMO).

19. The method of claim 18, wherein the transmit antenna array mode is selected in which an antenna weight vector of the transmitter is used.

20. The method of claim 19, wherein the antenna weight vector of the transmitter is a first eigenvector of a right eigenvector matrix, when a predetermined matrix of the at least one examined channel is set, and the right eigenvector matrix is computed through a singular value decomposition (SVD) of the set matrix.

21. The method of claim 18, wherein the transmit antenna array mode is selected in which an antenna weight vector of the receiver is used.

22. The method of claim 21, wherein the antenna weight vector of the transmitter is a first eigenvector of a left eigenvector matrix, when a predetermined matrix of the at least one examined channel is set, and the left eigenvector matrix is computed through a singular value decomposition (SVD) of the set matrix.

23. The method of claim 18, wherein the step of selecting the frequency band comprises the steps of:
setting a predetermined matrix of the at least one channel;
computing singular values through a singular value decomposition (SVD) of the set matrix; and
selecting a frequency band with a largest value of the computed singular values.

24. The method of claim 1, wherein the step of selecting the antenna transmission mode comprises the step of:
selecting a spatial multiplexing mode and the optimum frequency band, when the examined at least one channel is associated with a multiple-input multiple-output (MIMO).

25. The method of claim 24, wherein the step of selecting the frequency band comprises the steps of:
computing capacity values of channels based on a closed loop structure among the at least one channel; and
selecting a frequency band with a largest value of the computed capacity values.

26. The method of claim 24, wherein the step of selecting the frequency band comprises the steps of:
computing capacity values of channels based on an open loop structure among the at least one channel; and
selecting a frequency band with a largest value of the computed capacity values.

27. The method of claim 1, wherein the step of selecting the frequency band comprises the steps of:
measuring channel power values associated with frequency bands, when the examined at least one channel is associated with a multiple-input single-output (MISO); and
selecting a frequency band with a largest value of the measured channel power values.

28. The method of claim 1, wherein the step of selecting the frequency band comprises the steps of:
measuring channel power values associated with frequency bands, when the examined at least one channel is associated with a multiple-input single-output (MISO);
computing power sums between the measured channel power values according to the frequency bands; and
selecting a frequency band with a largest power sum.

29. The method of claim 1, wherein the step of selecting the frequency band comprises the steps of:
measuring channel power values associated with frequency bands, when the examined at least one channel is associated with a multiple-input multiple-output (MIMO);
computing power sums between the measured channel power values according to input channels; and
selecting a frequency band with a largest power sum.

30. The method of claim 1, wherein the step of selecting the frequency band comprises the steps of:
measuring channel power values associated with frequency bands, when the examined at least one channel is associated with a multiple-input multiple-output (MIMO);
summing the channel power values according to input channels;
computing power sums between the summed channel power values according to the frequency bands; and
selecting a frequency band with a largest power sum.

31. The method of claim 1, wherein the step of selecting the frequency band comprises the steps of:
computing singular values through a singular value decomposition (SVD) of a matrix of the at least one examined channel, when the examined at least one channel is associated with a multiple-input multiple-output (MIMO); and
selecting a frequency band with a largest value of the computed singular values.

32. The method of claim 1, wherein the step of selecting the frequency band comprises the steps of:
computing capacity values of channels based on a closed loop structure among the at least one channel, when the examining at least one channel is associated with a multiple-input multiple-output (MIMO); and
selecting a frequency band with a largest value of the computed capacity values.

33. The method of claim 1, wherein the step of selecting the frequency band comprises the steps of:
computing capacity values of channels based on an open loop structure among the at least one channel, when the examined at least one channel is associated with a multiple-input multiple-output (MIMO); and
selecting a frequency band with a largest value of the computed capacity values.

34. A system for allocating a frequency band in a communication system, comprising:
a receiver for examining at least one received channel, selecting antenna transmission mode based on the examined at least one channel, selecting an optimum frequency band based on the selected mode, and sending feedback information including the selection information; and
a transmitter for receiving the feedback information from the receiver and allocating a frequency band to the receiver according to the received feedback information.

35. The system of claim 34, wherein the transmitter transmits data to the receiver using the allocated frequency band.

36. The system of claim 34, wherein the receiver includes at least one of an index of the antenna transmission mode and an index of the frequency band in the feedback information.

37. The system of claim 36, wherein the index of the frequency band comprises:
a number of the frequency band;
channel performance information in the frequency band; and
frequency band level information mapped to the performance information.

38. The system of claim 34, wherein the receiver selects a maximal ratio combining (MRC) mode and the optimum frequency band, when the examined at least one channel is associated with a single-input multiple-output (SIMO).

39. The system of claim 38, wherein the receiver measures channel power values associated with frequency bands, computes power sums between the measured channel power values according to the frequency bands, and selects a frequency band with a largest power sum.

40. The system of claim 34, wherein the receiver selects an antenna selection diversity mode and the optimum frequency band, when the examined at least one channel is associated with a multiple-input single-output (MISO).

41. The system of claim 40, wherein the receiver measures channel power values associated with frequency bands, and selects a frequency band with a largest power value of the measured channel power values.

42. The system of claim 34, wherein the receiver selects a transmit antenna diversity mode and the optimum frequency band, when the examined at least one channel is associated with a multiple-input single-output (MISO).

43. The system of claim 42, wherein the receiver measures channel power values associated with frequency bands, computes power sums between the measured channel power values according to the frequency bands, and selects a frequency band with a largest power sum.

44. The system of claim 34, wherein the receiver selects a transmit antenna array mode and the optimum frequency band, when the examined at least one channel is associated with a multiple-input single-output (MISO).

45. The system of claim 44, wherein the receiver measures channel power values associated with frequency bands, computes power sums between the measured channel power values according to the frequency bands, and selects a frequency band with a largest power sum.

46. The system of claim 44, wherein the receiver selecting the transmit antenna array mode adds information about a transmit antennas factor to the feedback information.

47. The system of claim 34, wherein the receiver selects an antenna selection diversity mode and the optimum frequency band, when the examined at least one channel is associated with a multiple-input multiple-output (MIMO).

48. The system of claim 47, wherein the receiver measures channel power values associated with frequency bands, computes power sums between the measured channel power values according to the input channels, and selects a frequency band with a largest power sum.

49. The system of claim 34, wherein the receiver selects a transmit antenna diversity mode and the optimum frequency band, when the examined at least one channel is associated with a multiple-input multiple-output (MIMO).

50. The system of claim 49, wherein the receiver measures channel power values associated with frequency bands, sums the channel power values according to input channels, computes power sums between the summed channel power values according to the frequency bands, and selects a frequency band with a largest power sum.

51. The system of claim 34, wherein the receiver selects a transmit antenna array mode and the optimum frequency band, when the examined at least one channel is associated with a multiple-input multiple-output (MIMO).

52. The system of claim 51, wherein the receiver selects the transmit antenna array mode in which an antenna weight vector of the transmitter is used.

53. The system of claim 51, wherein the antenna weight vector of the transmitter is a first eigenvector of a right eigenvector matrix, when a predetermined matrix of the at least one examined channel is set, and the right eigenvector matrix is computed through a singular value decomposition (SVD) of the set matrix.

54. The system of claim 51, wherein the receiver selects the transmit antenna array mode in which an antenna weight vector of the receiver is used.

55. The system of claim 54, wherein the antenna weight vector of the transmitter is a first eigenvector of a left eigenvector matrix, when a predetermined matrix of the at least one examined channel is set, and the left eigenvector matrix is computed through a singular value decomposition (SVD) of the set matrix.

56. The system of claim 51, wherein the receiver sets a predetermined matrix of the at least one channel, computes singular values through a singular value decomposition (SVD) of the set matrix, and selects a frequency band with a largest value of the computed singular values.

57. The system of claim 34, wherein the receiver selects a spatial multiplexing mode and the optimum frequency band, when the examined at least one channel is associated with a multiple-input multiple-output (MIMO).

58. The system of claim 57, wherein the receiver computes capacity values of channels based on a closed loop structure among the at least one channel, and selects a frequency band with a largest value of the computed capacity values.

59. The system of claim 57, wherein the receiver computes capacity values of channels based on an open loop structure among the at least one channel, and selects a frequency band with a largest value of the computed capacity values.

60. The system of claim 34, wherein the receiver measures channel power values associated with frequency bands, when the examined at least one channel is associated with a multiple-input single-output (MISO), and selects a frequency band with a largest value of the measured channel power values.

61. The system of claim 34, wherein the receiver measures channel power values associated with frequency bands, when the examined at least one channel is associated with a multiple-input single-output (MISO), computes power sums between the measured channel power values according to the frequency bands, and selects a frequency band with a largest power sum.

62. The system of claim 34, wherein the receiver measures channel power values associated with frequency bands, when the examined at least one channel is associated with a multiple-input multiple-output (MIMO), computes power sums between the measured channel power values according to input channels, and selects a frequency band with a largest power sum.

63. The system of claim 34, wherein the receiver measures channel power values associated with frequency bands, when the examined at least one channel is associated with a multiple-input multiple-output (MIMO), sums the channel power values according to input channels, computes power sums between the summed channel power values according to the frequency bands, and selects a frequency band with a largest power sum.

64. The system of claim 34, wherein the receiver computes singular values through a singular value decomposition (SVD) of a matrix of the at least one examined channel, when the examined at least one channel is associated with a multiple-input multiple-output (MIMO), and selects a frequency band with a largest value of the computed singular values.

65. The system of claim 34, wherein the receiver computes capacity values of channels based on a closed loop structure among the at least one channel, when the examined at least one channel is associated with a multiple-input multiple-output (MIMO), and selects a frequency band with a largest value of the computed capacity values.

66. The system of claim 34, wherein the receiver computes capacity values of channels based on an open loop structure among the at least one channel, when the examined at least one channel is associated with a multiple-input multiple-output (MIMO), and selects a frequency band with a largest value of the computed capacity values.
